(19) United States
(12) Patent Application Publication
(10) Pub. No.: US 2014/0172821 A1
(43) Pub. Date: Jun. 19, 2014

(54) GENERATING FILTERS FOR REFINING SEARCH RESULTS

(71) Applicant: MICROSOFT CORPORATION, REDMOND, WA (US)

(72) Inventors: CHUANXIN HU, REDMOND, WA (US); WALTER SUN, REDMOND, WA (US); JINGFENG LI, REDMOND, WA (US); FLORIN O. FOLTA, REDMOND, WA (US); AARON YUEN, REDMOND, WA (US); YOGESH VAIDYA, REDMOND, WA (US); RAHUL LAL, REDMOND, WA (US); JIA MA, REDMOND, WA (US)

(73) Assignee: MICROSOFT CORPORATION, REDMOND, WA (US)

(21) Appl. No.: 13/720,641

(22) Filed: Dec. 19, 2012

(51) Int. Cl. G06F 17/30

(52) U.S. Cl. CPC G06F 17/3087
USPC 707/711

(57) ABSTRACT

Filters are generated by analyzing a set of search results most relevant to a search query to determine filter values that may be of most interest to the user. A search query is received and is classified into a query segment that best corresponds to the search query so that filter categories associated with the query segment can be identified. Based on an analysis of search results most relevant to the search query, metadata associated with these search results is used to formulate filter values for each filter category. The filter values are ordered based on their respective frequency of presence in the search results. The search results, along with the filter categories and filter values, are communicated for presentation.

### BACKGROUND

The amount of information and content available on the Internet continues to grow exponentially. Given the vast amount of information, search engines have been developed to facilitate web searching. For instance, a user may enter a search query comprising one or more terms that may be of interest to the user in an attempt to search for information and documents. After receiving a search query from the user, a search engine identifies documents and/or web pages that are relevant based on the search terms. Because of its utility, web searching, or the process of finding relevant web pages and documents for user-issued search queries has arguably become one of the most popular services on the Internet today. However, many times, search results retrieved by a search engine based solely on a search query may prevent a user from finding the desired information, especially if the search results are far too general or broad and would require the user to spend time sorting through the search results. As a result, a user may have to browse or search many documents and web pages to find the information the user is seeking.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer storage media for, among other things, generating filters for a particular search query from which the user may select to further refine the search results. Each filter may include a filter category and one or more filter values that are selected at least based on a query segment that is most applicable to the search query and a set of search results most relevant to the search query. For instance, for each search query, a query segment is determined. For example, for the search query “chicken,” the most applicable query segment may be determined to be “recipe.” Further, filter categories, including calories, ingredients, and cook time, may be predetermined to be associated with the “recipe” query segment or may be determined in real-time. In one embodiment, the filter values for each filter category are determined in real-time and are based on metawords associated with the search results. These filter values may further be ordered based on the frequency of the corresponding metaword in the search results.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for dynamically generating search filters for refining returned search results, in accordance with an embodiment of the present invention;

FIG. 3 is a process-flow diagram illustrating a method for dynamically generating search filters for refining returned search results, in accordance with an embodiment of the present invention;

FIGS. 4-9 illustrate exemplary screen shots of a search results page that includes search filters for refining returned search results, in accordance with embodiments of the present invention; and

FIGS. 10-11 are flow diagrams that illustrate exemplary methods of dynamically generating search filters for refining returned search results, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer storage media for, among other things, generating filters used by users to refine search results to provide the most useful information to the user based on the user's search query. Multiple filters may be generated for any given query segment, which may be an entity or a topic that is best correlated to the search query. “Restaurant,” “sports,” “recipe,” “shopping,” “people search,” and “entertainment” are just a few examples of query segments. Embodiments of the present invention allow users to select multiple filters for a single search query (e.g., “cuisine,” “rating,” and “price” for the query segment “restaurant”) such that a user may refine the search results to only display those for French restaurants having a four-star rating.

Further, embodiments of the present invention include the look and placement of the filters. For instance, in one embodiment, the filters may be placed inline below the search query box to provide users with a quick and easy way of applying the filters, as opposed to appearing somewhere else on the page where the user is less likely to see the filters.

Even further, embodiments of the present invention include the filtering facets displayed to the end users, which may be ordered by a histogram of search results. For example, for the query “Seattle restaurants,” if “French” ranks higher than “Italian,” not only will the filter value “French” be seen first in the list of filter values, but this means that the search results have more French restaurants than Italian restaurants, indicating the French restaurants may be more popular and hence of bigger value to the user.

Embodiments also include the ability to generate filters quickly for any query segment with low developer cost. For example, new query segments may be added to the data store at any time. Corresponding filter categories may also be added and retrieved when the corresponding query segment is determined to be most relevant or applicable to the present search query.

Accordingly, in one embodiment, the present invention is directed to one or more computer storage media having computer-executable instructions embodied thereon that, when executed by a computing device, cause the computing device to perform a method of dynamically generating search filters for refining returned search results. The method includes receiving a search query at a search engine and classifying the search query into a query segment. The query segment is one of a plurality of query segments that are predetermined by the search engine. Based on the classified query segment, the method further includes identifying one or more filter categories associated with the query segment. The one or more filter categories are predetermined for the particular query segment. A set of search results based on the search query is retrieved, and each search result in the set of search results is analyzed to identify one or more filter values for each of the one or more identified filter categories. Further, the method includes determining a display order of the one or more filter values for each of the one or more identified filter categories based on the retrieved set of search results and communicating the set of search results and the one or more filter categories and their respective one or more filter values in the determined display order for presentation in response to the received query.

In another embodiment, the present invention is directed to a computer system including one or more processors and one or more computer-readable media configured to dynamically generate search filters for refining returned search results. The computer system includes a query receiving component for receiving a search query at a search engine, a query classifier that classifies the search query into a query segment that is one of a plurality of query segments that are predetermined by the search engine, and a filter identification component that identifies one or more filter categories associated with the query segment based on the classified query segment. The one or more filter categories are predetermined for the particular query segment. The system further includes a search results component that uses the search query to identify a set of search results most relevant to the search query, a search results analysis component that analyzes each search result in the set of search results to identify the one or more filter values, and a histogram component that determines a display order of the one or more filter values for each of the one or more identified filter categories based on the analysis of the retrieved set of search results. The system additionally includes a communication component that communicates the one or more filter categories and their respective one or more filter values in the determined display order for presentation.

In yet another embodiment, the present invention is directed to a computerized method dynamically generating search filters for refining returned search results. The method includes, based on a search query received at a search engine, identifying one or more query segments that correspond to the search query, and assigning a confidence level to each of the one or more query segments. Further, the method includes, for the query segment having the highest confidence level, identifying one or more filter categories that have been predetermined to correspond to the query segment, and identifying a set of search results corresponding to the search query. The method also includes analyzing each search result in the set of search results to determine metawords associated with the search results, based on the determined metawords of the search results, identifying one or more filter values for each of the one or more identified filter categories, and determining a display order of the one or more filter values for each of the one or more filter categories. The method additionally includes communicating the set of search results corresponding to the search query and the one or more filter categories and their respective one or more filter values for presentation, receiving a first user selection of one of the one of more filter values in a first filter category, and communicating for presentation a first subset of the set of search results that correspond to the selected one of the one or more filter values in the first filter category.

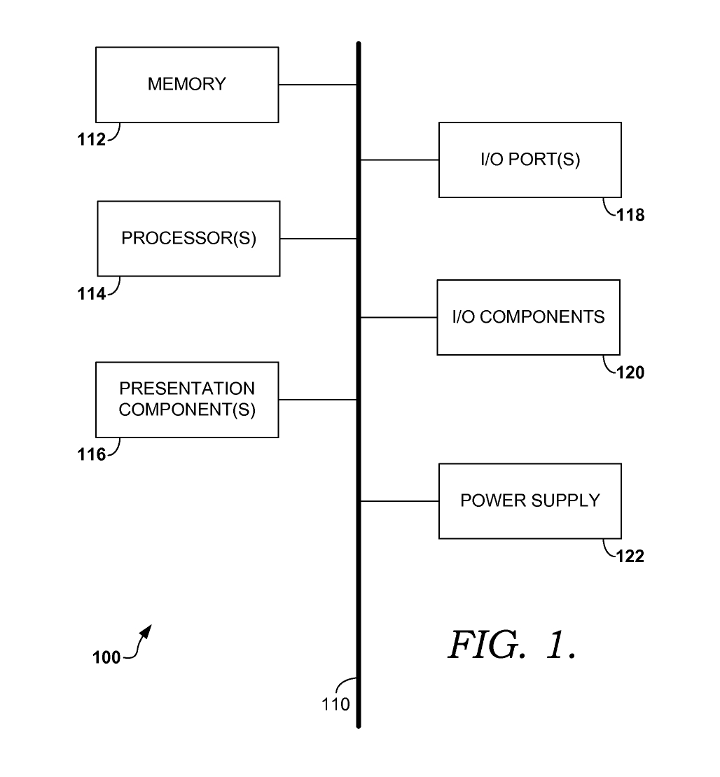

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search service, a Web browser, a set of one or more processes distributed on one or more computers, one or more stand-alone storage devices, a set of one or more other computing or storage devices, a combination of one or more of the above, and the like.

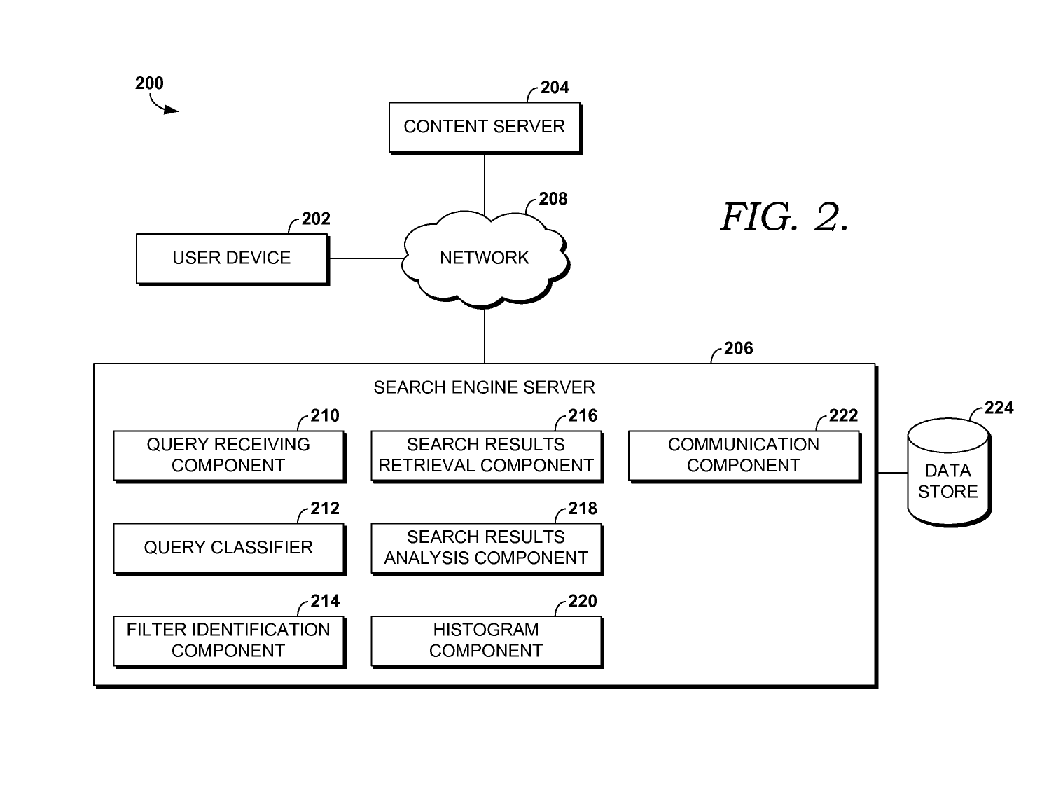

Referring now to FIG. 2, a block diagram is provided illustrating an exemplary system 200 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a user device 202, content server 204, and search engine server 206. Each of the components shown in FIG. 2 may be any type of computing device, such as computing device 100 described with reference to FIG. 1, for example. The components may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of user devices, content servers, and search engine servers may be employed within the system 200 within the scope of the present invention. Each may comprise a single device or multiple devices cooperating in a distributed environment. For instance, the search engine server 206 may comprise multiple devices arranged in a distributed environment that collectively provide the functionality of the search engine server 206 described herein. Additionally, other components not shown may also be included within the system 200.

The user device 202 may include any type of computing device, such as the computing device 100 described with reference to FIG. 1, for example. Generally, the client user device 202 includes a browser and a display. The browser, among other things, is configured to render search engine home pages (or other online landing pages), and render search engine results pages (SERPs) in association with the display of the user device 212. The browser is further configured to receive user input of requests for various web pages (including search engine home pages), receive user inputted search queries (generally inputted via a user interface presented on the display and permitting alpha-numeric and/or textual input into a designated search box) and to receive content for presentation on the display, for instance, from the search engine server 206. It should be noted that the functionality described herein as being performed by the browser may be performed by any other application capable of rendering Web content. Any and all such variations, and any combination thereof, are contemplated to be within the scope of embodiments of the present invention.

The content server 204 may act as a central unit for managing documents and other content that is needed during a web search. While not shown, it may interact with data store 224 that stores the documents that are searched during a web search.

The search engine server 206 generally operates to provide a user with one or more filters that can be used by the user to focus in on what the user is actually trying to search for. The process described herein is performed in real-time by the search engine server 206, and may be performed each time a search query is received by the search engine server. The search engine server analyzes a set of search results to determine filter values that are displayed and from which the user may select.

In the embodiment shown in FIG. 2, the search engine server 206 includes, among other things, a query receiving component 210, a query classifier 212, a filter identification component 214, a search results retrieval component 216, a search results analysis component 218, a histogram component 220, and a communication component 222. The search engine server 206 also has access to data store 224, which may store various documents and other content that is searchable and may be included in the set of search results most applicable to the received search query.

The query receiving component 210 is generally responsible for receiving the inputted search query and determining the next course of action. For instance, in one embodiment, the query receiving component 210 simply takes the search query and passes it to another component for handling, such as the query classifier 212. The query classifier 212 uses the search query to determine which query segment best fits the search query. In one embodiment, a plurality of query segments are predetermined by the search engine. Further, an algorithm is used to determine the most applicable query segment. In one embodiment, the algorithm analyzes the query segments by, for example, ranking the query segments or assigning one or more query segments a confidence level to determine the most relevant or most applicable query segment for the particular search query. Other methods not mentioned herein may also be used to determine the most relevant query segment for a particular search query. By way of example only and not limitation, a search query of “restaurants Seattle” may ultimately be assigned to a query segment of “restaurants.” Similarly, a search query of “chicken” may ultimately be assigned to a query segment of “recipe.” Even further, a search query of “Seattle Sounders” may be assigned to a query segment of “sports.” Additionally, a search query of “USA Olympics” may be assigned to a query segment of “time.” In one embodiment, the query classifier 212 accesses the data store 224 to retrieve the query segments.

The filter identification component 214 generally identifies filter categories. The filter categories may be stored in the data store 224 for retrieval. Once a query segment is assigned to the search query, the filter categories can be identified a variety of ways. For example, filter categories may be pre-assigned to each of the query segments. For example, the query segment “restaurant” may have pre-assigned filter categories of “price,” “cuisine,” and “rating.” Alternatively, the filter categories may not be predetermined for each query segment, and instead may be determined in real-time. For instance, a set of search results associated with the search query may be analyzed for associated metawords to determine the metawords most often associated with those search results. These metawords may then be used to formulate the filter categories. Other methods not described herein are contemplated to be within the scope of the present invention. As used herein, metawords are metadata tagged or associated with a particular document or web page that is capable of being searched and included in a set of search results. For instance, a web document with a subject matter of a recipe for chicken may be tagged with various metawords, including “30-minute cook time” and “200-300 calories.”

The search results retrieval component 216 generally identifies, from the data store 224, and optionally in conjunction with the content server 204, the most relevant search results based on the search query. There are various methods of identifying search results, and any of these methods are contemplated to be within the scope of the present invention.

The search results analysis component 218 generally analyzes the search results identified by the search results retrieval component 216 and determines filter values. Filter values may be determined in much the same way as filter values described herein. In one embodiment, filter values are predetermined, but in another embodiment, filter values are determined by analyzing metawords associated with the search results. Therefore, for two different search queries that fit into the “restaurant” query segment, the filter categories and the filter values that from which a user may select to refine the search results may vary. The metawords associated with the search results may have previously been associated with search results stored in the data store 224, for instance. For example, for a particular document that is included in a set of search results, that document may have previously been tagged with metawords, such as “Italian cuisine,” or “three star rating,” or “$,” indicating the average price for a meal. These tags may be updated on a regular basis to take into account new ratings from customers, new menus, new pricing, etc. In one instance, the tagging may be done when the documents are indexed by the search engine.

The histogram component 220 generally determines how the filter values are to be displayed to the user in the filters. As such, a display order of the filter values for the filter categories may be determined based on the analysis of the retrieved set of search results. In one embodiment, the metaword that most frequently is associated with search results in the set of search results most relevant to the search query is used to construct the filter value that is shown at the top of a list. In some embodiments, the filter category is displayed, and the user can choose a filter value from a dropdown list. As such, in this embodiment, the filter value associated with the most frequently tagged metaword from an analysis of the search results is the first filter value in the list of filter values, as it represents the filter value most likely to be chosen by the user based on its frequency in the search results. While a dropdown list of the filter values for each filter category has been described, other methods of presenting this information are possible and are contemplated to be within the scope of the present invention.

In one embodiment, the histogram component 220 selects a certain quantity of filter values to communicate for presentation so as to not overwhelm the user with many filter values. For instance, while there are many types of cuisine that may be found in a set of search results, the histogram component 220 may select the top five or ten types of cuisine to include in the list of filter values from which the user may select. Further, the histogram component 220, in one embodiment, may also include a filter value even if there are no associated search results. For instance, for certain filter categories, such as numerical categories (e.g., calories, time, price), a filter value may be presented to the user although there are no associated search results. For exemplary purposes only, for a filter category of “price” associated with a query segment of “restaurant,” even if there are no search results of restaurants associated with a price of “$$$$,” indicating an average high price for a meal, “$$$$” may be viewable to the user, but in one embodiment, may be non-selectable. A non-selectable filter value, in some cases, may be a different color or otherwise indicated as being non-selectable.

The communication component 222 generally communicates the identified filter categories and their respective filter values in the determined display order for presentation to the user. The communication component 222 also communicates the set of search results for presentation. Once the user has narrowed or refined the search results by using the filters, the refined sets of search results may also be communicated for presentation by the communication component 222.

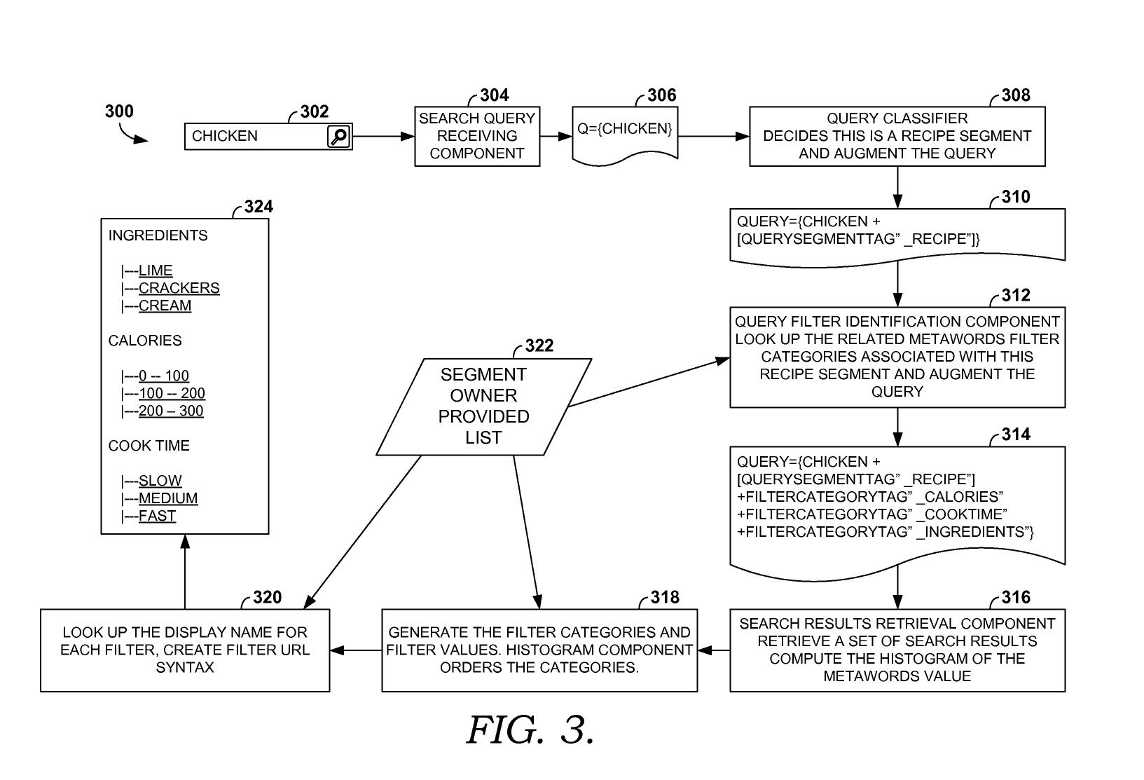

Referring now to FIG. 3, a process-flow diagram 300 is shown of a method for dynamically generating search filters for refining returned search results. Initially at box 302, a search query is entered into a search page associated with a search engine. Here, the search query is “chicken.” The search query is received at a component, shown as box 304, which may perform various operations on the query, such as parsing, determining the meaning of the query, etc., and form the syntax for the query, shown at box 306. At box 308, a query classifier decides that the query “chicken” is most likely to be classified as the query segment “recipe” and further develops the query syntax, shown at box 310. At box 312, a query filter identification component determines related metawords, which may be predetermined, and identifies one or more filter categories. Here, the filter categories are calories, cook time, and ingredients. The query is further developed at box 314. At box 316, a set of relevant search results are retrieved. A histogram is computed by analyzing the search results for tagged metawords that can be processed into filter values. At box 318, filter categories and filter values are generated, and at box 320, display names for the filters are determined. The filter URL syntax is created at box 320 as well. Segment owners may provide a list of filter categories that can be displayed for the user, shown at box 322. This list may be fed into various components shown in the process-flow diagram 300, as shown. At box 324, the filters have been created and are communicated for presentation along with the set of relevant search results.

Not shown in FIG. 3, but what is contemplated to be within the scope of the present invention, is the return of the user-selected filter value through the search engine, and subsequently the return of a refined set of search results for presentation to the user based on the user-selected filter value. For instance, referring to the example provided in FIG. 3, if the user selects the “calorie” filter category and the “200-300” filter value, only those search results that are tagged with a metaword indicating that the recipes in those documents are 200-300 calories are returned as the set of refined search results. Even after refining the search results once by using the filters, the user can further refine the search results again using the filters. So using the example of FIG. 3, a user could narrow search results to recipes with chicken, having 200-300 calories, with a medium cook time, and that includes cream as an ingredient. This allows for the users to customize the search results multiple times to achieve the desired answer based on the inputted search query.

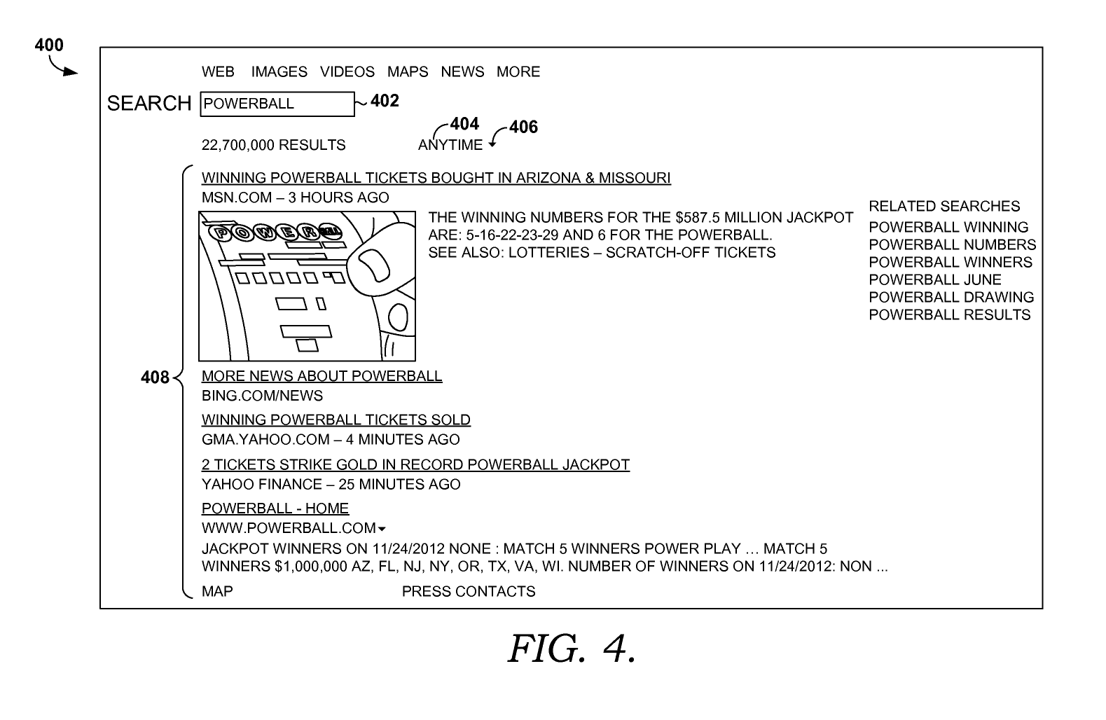

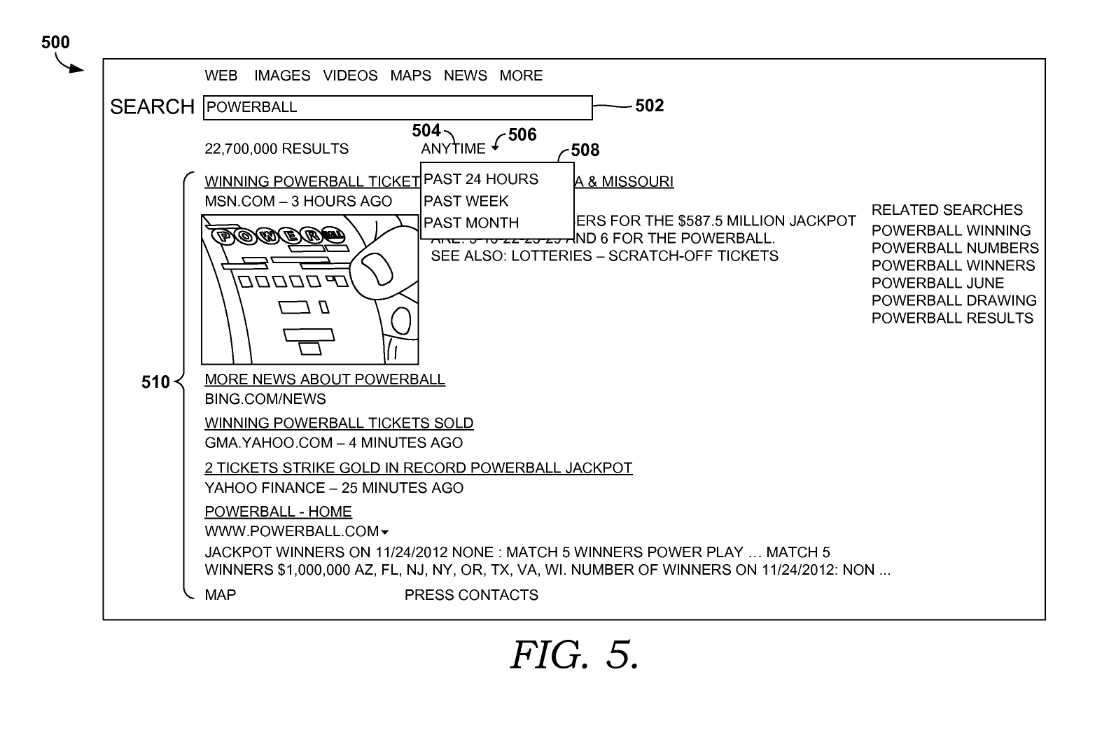

Turning now to FIG. 4, a screen shot 400 is shown of a search results page that includes a search box 402 where a user inputs a query, a time filter 404, a dropdown arrow 406, and a set of search results found to be most relevant to the search query of “Powerball.” FIG. 4 illustrates an example of a time filter that allows the user to refine search results based on when the search result was posted as a document on the Internet. FIG. 5 is another screen shot 500 that further illustrates this concept, as it shows a search box, a filter category 504, a dropdown arrow 506, a dropdown list of filter values 508, and search results 510. The dropdown list of filter values 508 provides the filter values “past 24 hours,” “past week,” and “past month.” Further, the filters are located just underneath the query box so that user does not have to spend time searching for the filters. They are easy to find and easy to use.

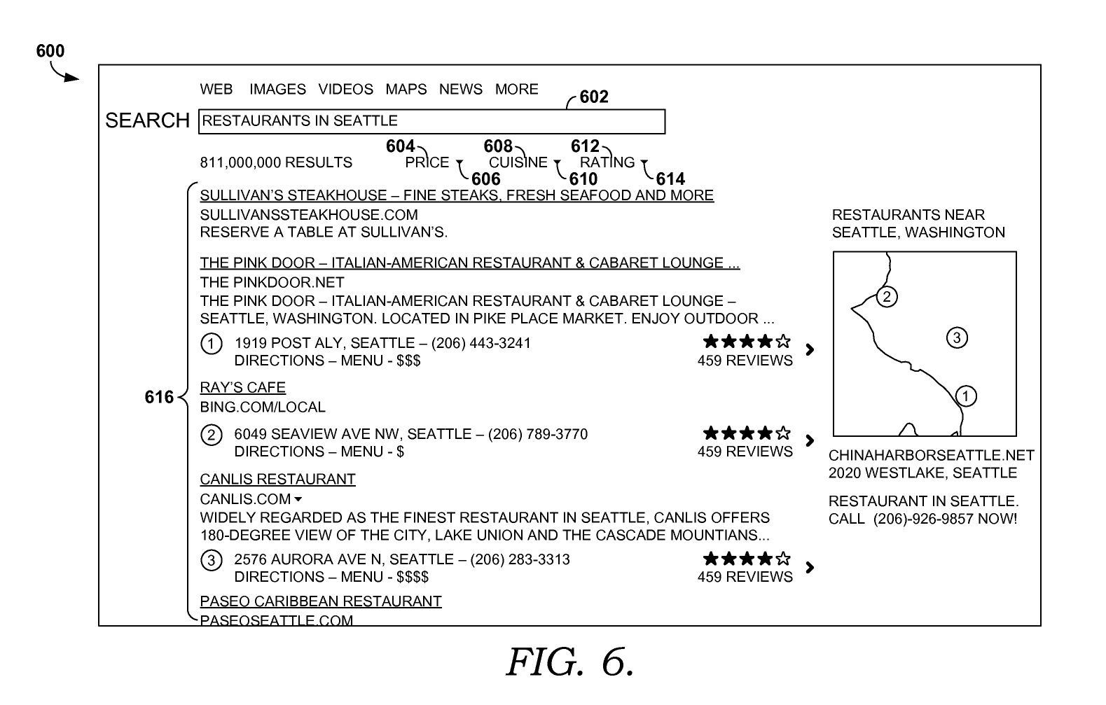

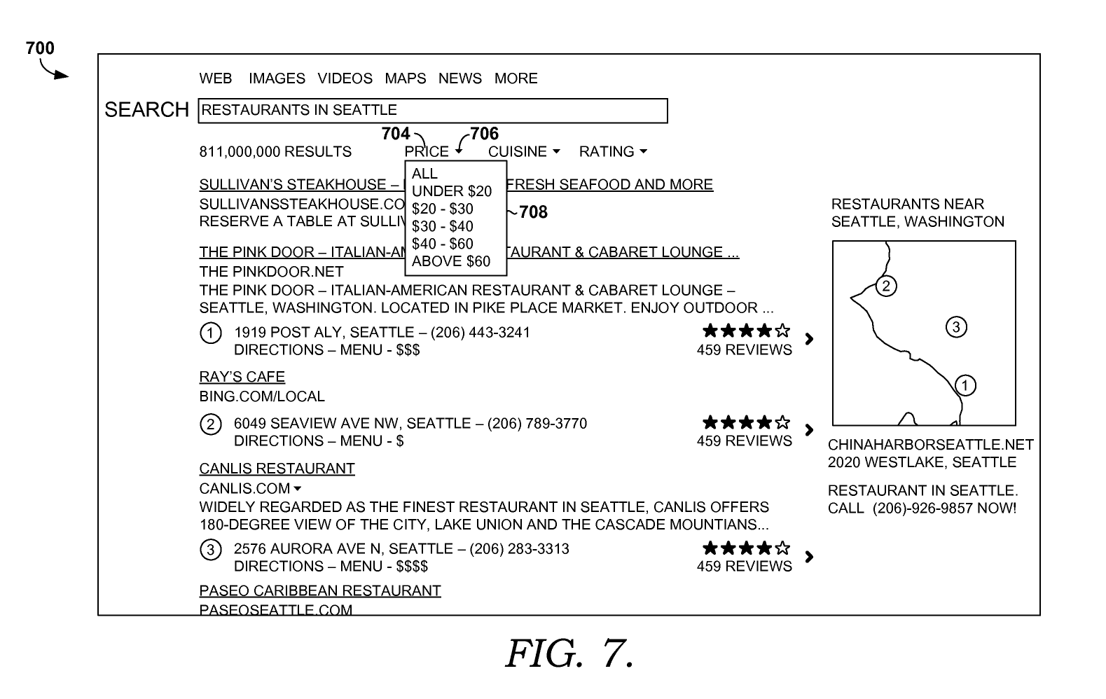

In FIG. 6, a screen shot 600 is illustrated of a search results page that includes a search box 602, three filter categories (604, 608, and 612), three dropdown arrows (606, 610, 614) corresponding to the three filter categories, and search results 616. Here, the search query is “restaurants in Seattle,” and so it has been determined that this query is best associated with the query segment “restaurant,” which corresponds to the filter categories of “price,” “cuisine,” and “rating.” Again, the filters are physically located directly underneath the search box for user convenience and ease of use, but the filters could be located anywhere else on the search results page. The location of the filters in FIG. 6 and the other figures is provided for exemplary purposes only, and not limitation. FIG. 7 illustrates the same search results page 700 as is shown in FIG. 6, but shows the dropdown list of filter values 708 for the filter category “price.” In one embodiment, if there are not search results associated with “above $60,” for example, this filter value may be non-selectable, which may be indicated by a color change or highlighting of this filter value. Here, the filter values may be displayed based on a user selection of the dropdown arrow 706 associated with the “price” filter category 704.

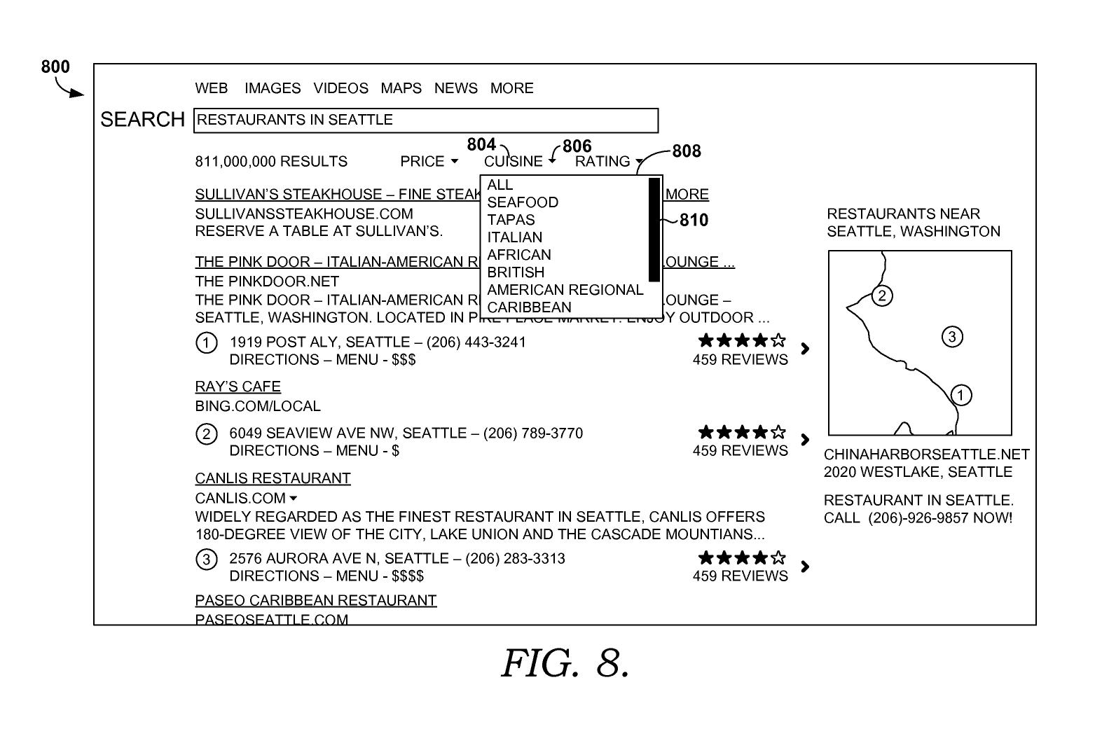

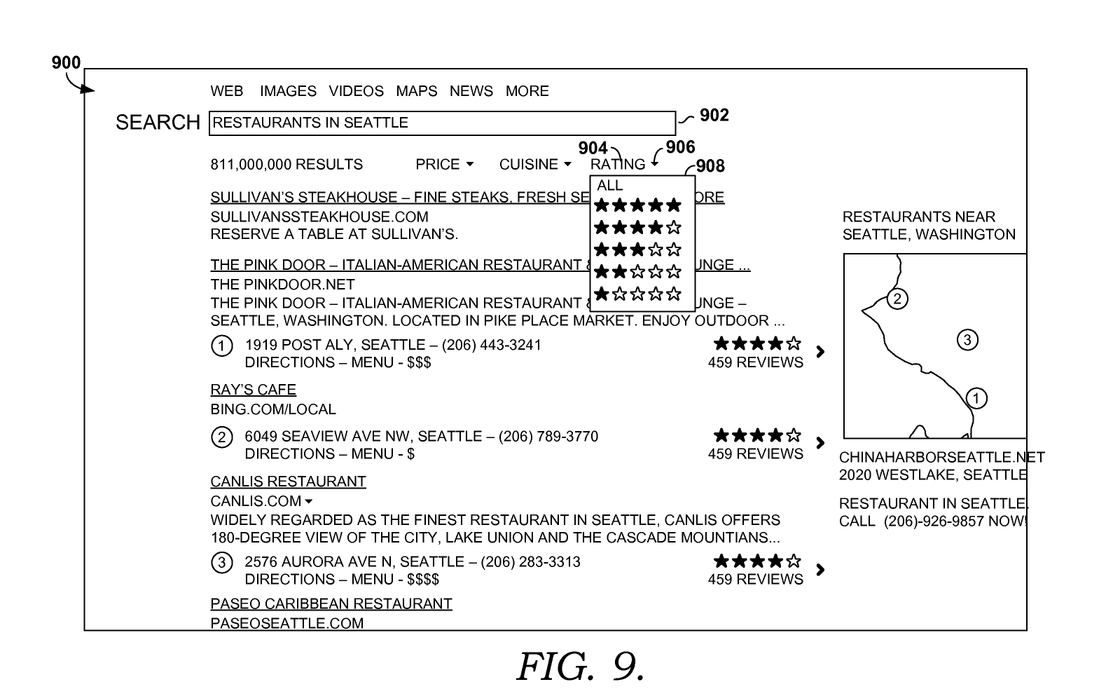

FIG. 8 illustrates the same search results page 800 including the filter category “cuisine” 804, the dropdown arrow 806, and the dropdown list of filter values 808. Here, there are many filter values associated with “cuisine,” and thus a scroll bar 810 is also used. Again, in one embodiment, these filter values may be predetermined, but in another embodiment, are dynamically determined by the search engine based on metawords associated with a set of search results found to be most relevant to the search query. The histogram component may also order the display of filter values so the metawords most frequently tagged in the search results are used as the filter values displayed at the top of a list of filter values. The top-most filter value may be associated with the metaword most frequently tagged in the set of search results. FIG. 9 illustrates, again, the same search results page 900, including the “rating” filter category 904, the dropdown arrow 906 for the “rating” filter category, and the dropdown list of filter values 908.

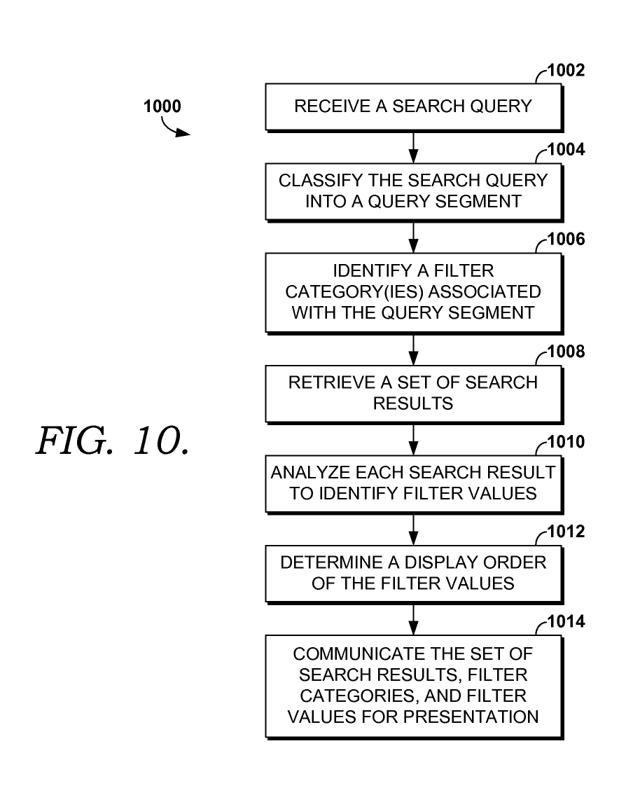

Referring now to FIG. 10, a flow diagram is illustrated of an exemplary method 1000 for dynamically generating search filters for refining returned search results. At step 1002, a search query is received and at step 1004, the search query is classified into a query segment. In one embodiment, the query segment may be one of a plurality of query segments that are predetermined by the search engine. In one embodiment, an algorithm is used to identify the most relevant or best fitting query segment for the particular search query. The algorithm may assign a confidence score or may otherwise rank the query segments to identify the most relevant one for the search query, such as the query segment having the highest confidence level, indicating that the selected query segment best corresponds to the search query. For example, for the query “chicken,” query segments of “restaurant,” “recipe,” and “shopping” may be ranked based on a confidence level that each is the best query segment for the query. Using this simple example, “recipe” would likely be selected as the most relevant query segment for “chicken.”

At step 1006, one or more filter categories associated with the query segment are identified. As mentioned, filter categories may be predetermined and pre-associated with query segments, or may be determined in real-time. If the filter categories are predetermined, a data store, such as the data store 224 shown in FIG. 2 may be accessed to retrieve the filter categories associated with the selected query segment. In another embodiment, however, if the filter categories are not predetermined, they may be identified in real-time, such as each time a search query is received. For example, a set of search results may first be identified based on the search query, and metadata or metawords associated with these search results may be analyzed to identify the metawords most often tagged in association with the search results. These metawords can be used as the basis for identifying the most relevant filter categories. In yet another embodiment, a combination of real-time and predetermined filter categories may be employed.

A set of search results is retrieved at step 1008. Many methods can be utilized to identify the most relevant search results from a plurality of search results, and any of these methods is contemplated to be within the scope of the present invention. At step 1010, each search result retrieved is analyzed to identify filter values for the identified filter categories. The analyzing, in one embodiment, includes identifying the associated metawords from each search result and grouping the same or similar metawords together to determine the metawords most frequently associated with the search results. As mentioned, metadata, such as metawords, associated with each of the search results may be analyzed and used to formulate filter values. Metawords may previously have been tagged onto individual search results so that the filter values can efficiently be analyzed. A metaword, in one embodiment, is the same as an associated filter value, but in another embodiment, the filter value is different than the metaword, such as if a different word is used that conveys the same meaning as the metaword. In one embodiment, each search result has one or more associated metawords that can be used to formulate filter values.

At step 1012, a display order of the filter values is determined based on the analysis of the search results. As such, the analysis of the search results may not only identify the most relevant filter values for the search query, but may also determine the display order of these filter values. In one embodiment, the filter value corresponding to the metaword most frequently associated with the search results is the first (or top) filter value displayed to the user in a list of filter values. The most popular filter value may also be displayed first. Alternatively, the filter values that are time-based or numerical may be displayed in numerical order (e.g., past 24 hours, past week, past month) (e.g., *, **, ***, ****) (e.g., 0-100, 100-200, 200-300). At step 1014, the set of search results, filter categories, and the filter values are communicated for presentation.

In one embodiment, once the filters and search results are displayed for the user, a first user selection of one of the filter values from a first filter category is received by the search engine. A first subset of search results is retrieved that have been determined to have a metaword that corresponds to the selected filter value. This first subset of search results is then communicated for presentation to the user. This process may continue (e.g., the user continuing to refine the search results by selecting different filter values) until the user has found the information he or she is looking for. As such, the method may continue with receiving a second user selection of a filter value or a second filter category. A second subset of search results is retrieved that have been determined to have a metaword that corresponds to the selected filter value. Further, the second subset of search results is communicated for presentation. In one embodiment, all of the search results in the second subset are included in the first subset, and all of the search results in the first and second subset are included in the set of search results originally communicated for presentation.

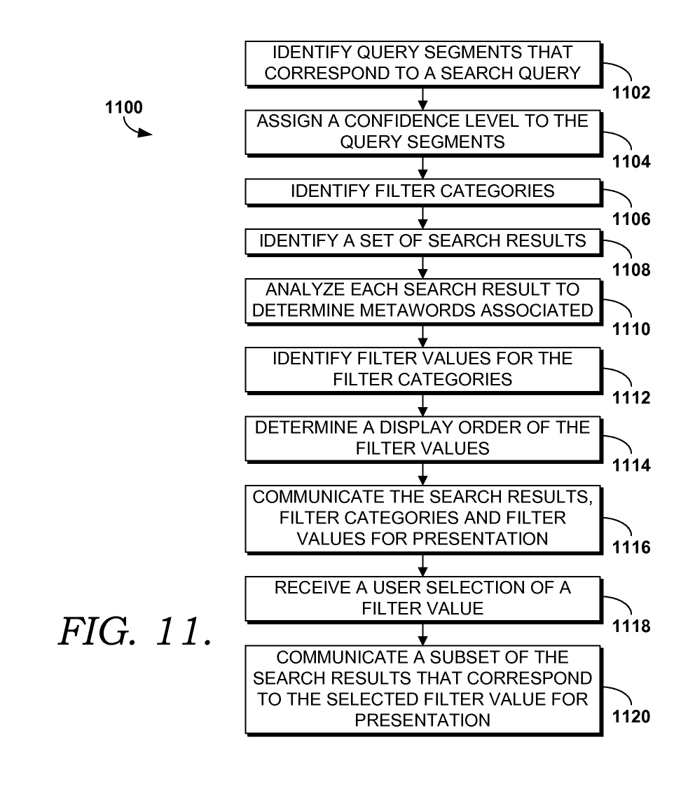

Turning now to FIG. 11, a flow diagram is illustrated of another exemplary method 1100 for dynamically generating search filters for refining returned search results. Initially at step 1102, query segments are identified that correspond to a search query received at a search engine, such as, for example, a search query inputted by a user into a search engine. At step 1104, a confidence level is assigned to each of the query segments. As mentioned, there are many alternative ways of determining the query segments that best correlates to the search query. In one embodiment, a confidence level, such as a numerical score, is assigned to each query segment so that the query segment with the highest confidence score is the one that is selected for that search query. At step 1106, one or more filter categories are identified for the query segment having the highest confidence level. In one embodiment, the filter categories are predetermined to correspond to the query segment, but in an alternative embodiment, the filter categories are determined in real-time, such as by an analysis of the search results to identify the most frequently used metawords in association with the search results.

At step 1108, a set of search results is identified corresponding to the search query. Search results may be determined in one of many methods. Any of these methods are contemplated to be within the scope of the present invention. Each search result is analyzed, shown at step 1110, to determine metawords associated with the search results. Metawords, in one embodiment, are metadata that can be associated with particular documents or web pages that are searchable for determine the set of search results. In accordance with the present invention, metawords may include for instance, a type of cuisine associated with a web page or document, a price range, a location, a calorie range for a recipe, etc. Once the search results have been analyzed for metawords, filter values are identified for the filter categories, shown at step 1112. The filter values for each of the identified filter categories are a predetermined quantity of metawords most frequently associated with the search results. In one instance, the identified metawords associated with the search results are the filter values, but in another instance, the metawords are used to formulate the filter values. For instance, a metaword may be “around 150 calories,” but the filter value may be “100-200 calories.” In one embodiment, the filter values are identified in real-time each time the search engine receives a search query.

At step 1114, a display order of the filter values is determined for each of the filter categories. The display order may be based on a frequency of each of the metawords corresponding to the filter values in the search results. For instance, if a particular metaword is associated with 45 of the 100 search results and this represents the most frequent associated of the particular metaword to the search results, the filter value associated with this metaword may appear first or at the top of a list of filter values. Continuing with this example, if another metaword is associated with 30 of the 100 search results and this is the second most frequent metaword associated with the search results, the filter value associated with this metaword may be the next or second filter value in the list of filter values. In one case, for the query “Seattle restaurants,” if the user sees “French” before “Italian” in the list of filter values for the filter category “cuisine,” the search results may have more French restaurants than Italian restaurants, indicating that French restaurants are more popular and thus may be a bigger value to the end users using the search engine. The determination of a display order based on metawords may be performed for some but not all of the filter categories, in one embodiment. For instance, the filter category “price” may list filter values (e.g., $, $$, $$$, $$$$) in numerical order regardless of the metawords associated with the search results. At step 1116, the search results, filter categories, and filter values are communicated for presentation. These items may be communicated for presentation to the end user device, such as user device 202 shown in relation to FIG. 2.

Once the filter categories and associated filter values are communicated for presentation on the user device and are viewable by the user, a user selection of a filter value is received, shown at step 1118. For instance, a user may have selected a filter value associated with a particular filter category. At step 1120, a subset of the set of search results that corresponds to the selected filter value is communicated for presentation, such as to the user device 202 of FIG. 2. As such, in one embodiment, the search results of the subset of search results are all included in the set of search results initially returned to the user based on the search query. In one embodiment, the user may further refine the search results by continuing to select various filter values until the search results answer the user's initial question or until the user has found the information for which he or she is looking. For example and not limitation, the user in one example may be able to find a French restaurant having a four-star rating by using two of the filters that may be presented for a “restaurant” query segment.

In one embodiment, the filter categories are located on the search results page directly below the search box, as shown in various figures herein, including FIGS. 4-9. While the filters may be located anywhere on the search results page or even on another page, having the filters located nearby the search box, such as directly below the search box, allows for a better user experience as the user is more likely to see the filters at this location than in some other part of the page.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer storage media having computer-executable instructions embodied thereon that, when executed by a computing device, cause the computing device to perform a method of dynamically generating search filters for refining returned search results, the method comprising:
receiving a search query at a search engine;
classifying the search query into a query segment, wherein the query segment is one of a plurality of query segments that are predetermined by the search engine;
based on the classified query segment, identifying one or more filter categories associated with the query segment, wherein the one or more filter categories are predetermined for the particular query segment;
retrieving a set of search results based on the search query;
analyzing each search result in the set of search results to identify one or more filter values for each of the one or more identified filter categories;
determining a display order of the one or more filter values for each of the one or more identified filter categories based on the retrieved set of search results; and
communicating the set of search results and the one or more filter categories and their respective one or more filter values in the determined display order for presentation in response to the received query.

2. The media of claim 1, wherein classifying the search query into a query segment further comprises:
computing a confidence level for each of at least a subset of the plurality of query segments; and
selecting the query segment that has the highest confidence level, indicating that the selected query segment best corresponds to the search query.

3. The media of claim 1, wherein each search result of the set of search results has one or more associated metawords.

4. The media of claim 3, wherein analyzing each search result in the set of search results further comprises:
identifying the associated metawords from each search result; and
grouping the associated metawords to determine the metawords most frequently associated with the search results.

5. The media of claim 4, further comprising converting the most frequently associated metawords into the one or more filter values.

6. The media of claim 1, wherein the display order comprises ordering the one or more filter values from most frequent to least frequent.

7. The media of claim 1, wherein the one or more identified filter categories are displayed near a search box on a search results page with the set of search results.

8. The media of claim 7, wherein the one or more identified filter categories are displayed on the search results page directly below the search box.

9. The media of claim 1, wherein the one or more identified filter values are displayed in a list of filter values in a drop-down list format.

10. The media of claim 9, wherein a filter value that does not correspond to any of the search results is viewable in the list of filter values but is not user-selectable.

11. The media of claim 1, further comprising:
receiving a first user selection of one of the one or more filter values of a first filter category; and
retrieving a first subset of the set of search results that have been determined to have a metaword that corresponds to the selected filter value; and
communicating for presentation the first subset of the set of search results.

12. The media of claim 11, further comprising:
receiving a second user selection of one of the one or more filter values of a second filter category;
retrieving a second subset of the first subset of the set of search results that have been determined to have a metaword that corresponds to the selected filter value; and
communicating for presentation the second subset of the first subset set of search results, wherein all of the search results in the second subset are included in the first subset of search results.

13. A computer system including one or more processors and one or more computer-readable media configured to dynamically generate search filters for refining returned search results, the computer system comprising:
a query receiving component for receiving a search query at a search engine;
a query classifier that classifies the search query into a query segment that is one of a plurality of query segments that are predetermined by the search engine;
a filter identification component that identifies one or more filter categories associated with the query segment based on the classified query segment, wherein the one or more filter categories are predetermined for the particular query segment;
a search results component that uses the search query to identify a set of search results most relevant to the search query;
a search results analysis component that analyzes each search result in the set of search results to identify the one or more filter values;
a histogram component that determines a display order of the one or more filter values for each of the one or more identified filter categories based on the analysis of the retrieved set of search results; and
a communication component that communicates the one or more filter categories and their respective one or more filter values in the determined display order for presentation.

14. A computerized method dynamically generating search filters for refining returned search results, the method comprising:
based on a search query received at a search engine, identifying one or more query segments that correspond to the search query;
assigning a confidence level to each of the one or more query segments;
for the query segment having the highest confidence level, identifying one or more filter categories that have been predetermined to correspond to the query segment;
identifying a set of search results corresponding to the search query;
analyzing each search result in the set of search results to determine metawords associated with the search results;
based on the determined metawords of the search results, identifying one or more filter values for each of the one or more identified filter categories;
determining a display order of the one or more filter values for each of the one or more filter categories;
communicating the set of search results corresponding to the search query and the one or more filter categories and their respective one or more filter values for presentation;
receiving a first user selection of one of the one of more filter values in a first filter category; and
communicating for presentation a first subset of the set of search results that correspond to the selected one of the one or more filter values in the first filter category.

15. The method of claim 14, wherein the one or more query segments are predetermined.

16. The method of claim 14, wherein the identified one or more filter values for each of the one or more identified are a predetermined quantity of the metawords most frequently associated with the search results.

17. The method of claim 14, wherein the one or more filter values are identified in real-time each time the search engine receives a search query.

18. The method of claim 14, wherein the one or more filter categories are displayed on a search results page directly below a search box where the search query is input.

19. The method of claim 14, wherein the display order of the one or more filter values is based on a frequency of each of the metawords corresponding to the one or more filter values in the search results.

20. The method of claim 19, wherein a first filter value displayed in a list of the filter values for a particular filter category is the filter value corresponding to the metaword most frequently associated with the search results.
